(19) United States
(12) Patent Application Publication
(10) Pub. No.: US 2025/0306810 A1
(43) Pub. Date: Oct. 2, 2025

(54) INFORMATION PROCESS SYSTEM, NON-TRANSITORY COMPUTER READABLE MEDIUM, AND INFORMATION PROCESS METHOD

(71) Applicant: FUJIFILM Business Innovation Corp., Tokyo (JP)

(72) Inventors: Kazuki NAGASHIMA, Kanagawa (JP); Bo LIU, Kanagawa (JP); Mari KODAMA, Kanagawa (JP)

(73) Assignee: FUJIFILM Business Innovation Corp., Tokyo (JP)

(21) Appl. No.: 18/761,389

(22) Filed: Jul. 2, 2024

(30) Foreign Application Priority Data
Mar. 27, 2024 (JP) 2024-052546

(51) Int. Cl. G06F 3/12

(52) U.S. Cl. CPC G06F 3/1208; G06F 3/1237; G06F 3/1288

(57) ABSTRACT

An information processing system includes at least one processor configured to: extract a content designated for printing from printed material data; and present a print-candidate image in which the content designated for printing is disposed in a layout different from a layout of the printed material data.

### CROSS-REFERENCE TO RELATED APPLICATIONS

This application is based on and claims priority under 35 USC 119 from Japanese Patent Application No. 2024-052546 filed Mar. 27, 2024.

### BACKGROUND

### (i) Technical Field

The present disclosure relates to an information processing system, a non-transitory computer readable medium, and an information processing method.

### (ii) Related Art

Japanese Unexamined Patent Application Publication No. 2010-117950 describes a layout editor by which containers for laying out contents are automatically generated and disposed to place multiple contents within the sheet size and that thereby enables the multiple contents to be laid out.

### SUMMARY

Aspects of non-limiting embodiments of the present disclosure relate to extracting a content designated for printing and presenting a print-candidate image where the content is disposed in a layout different from the layout of printed material data.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing system including at least one processor configured to: extract a content designated for printing from printed material data; and present a print-candidate image in which the content designated for printing is disposed in a layout different from a layout of the printed material data.

### BRIEF DESCRIPTION OF THE DRAWINGS

An exemplary embodiment of the present disclosure will be described in detail based on the following figures, wherein:

FIG. 1 is a block diagram illustrating an example electrical configuration of an information processing system according to the exemplary embodiment;

FIG. 2 is a block diagram illustrating an example functional configuration of the information processing system according to the exemplary embodiment;

FIG. 3 is a conceptual view illustrating an example of how a content is extracted from printed material data in the information processing system according to the exemplary embodiment;

FIG. 4 is a conceptual view illustrating another example of how a content is extracted from printed material data in the information processing system according to the exemplary embodiment;

FIG. 5 is a table illustrating an example of contents designated for printing and attributes of each content in the information processing system according to the exemplary embodiment;

FIG. 6A is a view illustrating an example layout in which images serving as contents are disposed in the information processing system according to the exemplary embodiment;

FIG. 6B is a view illustrating a state where an image is disposed in the layout in FIG. 6A;

FIG. 7A is a view illustrating another example layout in which images serving as contents are disposed in the information processing system according to the exemplary embodiment;

FIG. 7B is a view illustrating a state where an image is disposed in the layout in FIG. 7A;

FIG. 8A is a view illustrating an example layout in which characters serving as contents are disposed in the information processing system according to the exemplary embodiment;

FIG. 8B is a view illustrating a state where e-mail addresses serving as the characters are disposed in the layout in FIG. 8A; and

FIG. 9 is a flowchart illustrating an example of a print-candidate image presentation process in the information processing system according to the exemplary embodiment.

### DETAILED DESCRIPTION

Hereinafter, an information processing system, an information processing program, and an information processing method according to an exemplary embodiment of the present disclosure will be described with reference to the drawings. It is meant that components denoted by the same reference numerals in the drawings are the same components. However, unless otherwise stated in the specification, each component is not limited to one component, and multiple components may be present in plurality.

Description of repeated configurations and reference numerals in the drawings is omitted on occasions. The present disclosure is not limited to the exemplary embodiment and may be implemented within the scope of the purpose of the present disclosure in such a manner that a change is appropriately made such as omitting a configuration, replacing a configuration with a different configuration, and using an exemplary embodiment and any of various modifications in combination with each other.

### Information Processing System

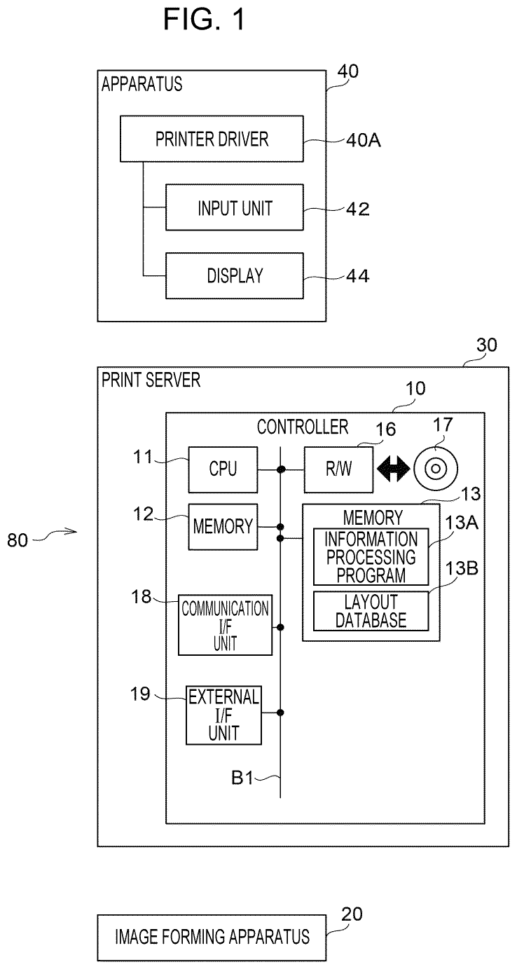

An information processing system 80 illustrated in FIG. 1 is a system built up in a print server 30 allowed to communicate with an image forming apparatus 20 and an apparatus 40 via a network. The term “system” in the present disclosure includes any of a system built up by using a single apparatus, by using multiple apparatuses, and in a higher level apparatus or system.

That is, the information processing system 80 of the present disclosure may be built up by using multiple apparatuses other than the print server 30. For example, the information processing system 80 of this exemplary embodiment may be built up including the image forming apparatus 20, the apparatus 40, and other apparatuses connected to the print server 30 via the network. Alternatively, the information processing system 80 of the present disclosure may be built up in the image forming apparatus 20 or the apparatus 40, not in the print server 30.

Various processes executed by the information processing system 80 may be executed by a cloud, an on-premise server, an edge server, an end point, or the like.

The information processing system 80 extracts contents designated by a user for printing from printed material data (described in detail later). The information processing system 80 also presents, to the user, a print-candidate image in which the content is disposed in a layout different from the layout of the original printed material data. The information processing system 80 then causes the image forming apparatus 20 to execute printing of conversion data generated on the basis of the print-candidate image selected by the user.

The information processing system 80 enhances the visibility of a content in the printed material and saves sheets as compared with a case where the information processing system 80 is not used.

### Image Forming Apparatus

The image forming apparatus 20 receives a job through an input operation by the user and executes the designated job. An example of the job executed by the image forming apparatus 20 is a print job by which a document image generated from a read document or the like is formed on the recording medium such as a sheet.

Reading a document by the image forming apparatus 20 includes reading a document on the platen glass of the image forming apparatus 20 and reading printed material data acquired from the apparatus 40 connected via the network. In the present disclosure, the image forming apparatus 20 acquires the printed material data from the apparatus 40 via the print server 30.

Further, reading a document by the image forming apparatus 20 includes reading conversion data acquired from the print server 30 connected via the network. In the present disclosure, the image forming apparatus 20 acquires the conversion data from the print server 30.

### Apparatus

The apparatus 40 is a terminal capable of generating printed material data caused by the user to be printed by the image forming apparatus 20 and is, for example, a personal computer, a tablet, or a smartphone used by the user. The apparatus 40 is capable of reading printed material data from a web site on the Internet, from data stored in the memory of the apparatus 40, from a scanner, or other apparatuses.

The apparatus 40 includes an input unit 42 and a display 44. The input unit 42 is an interface for inputting various processes to be executed by the apparatus 40 and includes a keyboard, a mouse, and the like.

The user designates printed material data to be printed by the image forming apparatus 20, by using the input unit 42. The user also designates one or more contents to be printed by the image forming apparatus 20 from among the printed material data, by using the input unit 42 (described in detail later).

The printed material data is data including a content designated for printing (also referred to as a print-designated content) and a content not designated for printing.

Further, the user gives an instruction (selection information) to print a print-candidate image in which the print-designated content is disposed in a layout different from or identical to the layout in the printed material data, by using the input unit 42. Alternatively, the user gives an instruction (non-selection information) to the image forming apparatus 20 not to print a print-candidate image, by using the input unit 42.

Further, the user may generate a layout (generated layout information) in which a print-designated content is disposed, by using the input unit 42.

Information regarding designation of printed material data, designation of one or more contents to be printed, an instruction to print a print-candidate image, and layout generation each of which is performed by using the input unit 42 is acquired by the print server 30 via a printer driver 40A installed on the apparatus 40.

The display 44 is an interface for displaying information for inputting various processes to be executed by the apparatus 40 and includes a display screen. An image or the like is displayed on the display 44 in accordance with an input operation by the user or a process by the apparatus 40, or the like.

In addition, information for an information processing program 13A (described later) is displayed on the display 44. The user may perform an operation for starting or terminating the information processing program 13A, by using the input unit 42.

The display 44 may also be formed as a display screen formed by combining, for example, a touch panel with a liquid crystal display, an organic EL display, or the like. In this case, the user may use the display 44 to input various pieces of information to the input unit 42.

### Print Server

The print server 30 includes a controller 10.

### Electrical Configuration of Controller

The controller 10 includes a central processing unit (CPU: a processor) 11, a memory 12 serving as a temporary storage, a nonvolatile memory 13, a medium reader/writer (R/W) 16, a communication interface (I/F) unit 18, and an external I/F unit 19. The CPU 11, the memory 12, the memory 13, the medium reader/writer 16, the communication I/F unit 18, and the external I/F unit 19 are connected to each other via a bus B1.

The CPU 11 controls the overall operations of the controller 10. The medium reader/writer 16 reads out information written to a recording medium 17 and writes information to the recording medium 17. The communication I/F unit 18 is an interface for enabling the controller 10 to communicate with, for example, a server outside the controller 10 and various terminals used by the user. For the communication I/F unit 18, communication standards such as Wi-Fi (registered trademark), Bluetooth (registered trademark), a standard for a local area network (LAN), and the like are used.

### Memory

The memory 13 is implemented by a hard disk drive (HDD), a solid state drive (SSD), a flash memory, or the like. The information processing program 13A is stored in the memory 13 serving as a storage medium. The information processing program 13A is stored in the memory 13 in such a manner that the recording medium 17 having the information processing program 13A written thereto is set in the medium reader/writer 16 and that the medium reader/writer 16 reads out the information processing program 13A from the recording medium 17. The CPU 11 reads out the information processing program 13A from the memory 13, loads the information processing program 13A into the memory 12, and serially executes processes of the information processing program 13A. The memory 13 stores a layout database 13B (described later).

### Functional Configuration of Controller

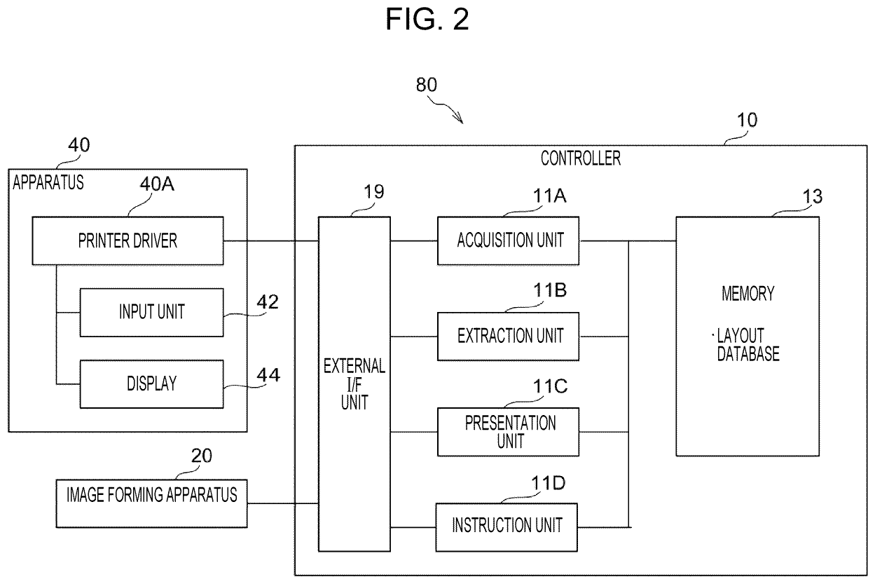

The functional configuration of the controller 10 according to this exemplary embodiment will then be described with reference to FIG. 2. As illustrated in FIG. 2, the controller 10 includes an acquisition unit 11A, an extraction unit 11B, a presentation unit 11C, and an instruction unit 11D. The CPU 11 of the controller 10 runs the information processing program 13A and thereby functions as the acquisition unit 11A, the extraction unit 11B, the presentation unit 11C, and the instruction unit 11D.

### Acquisition Unit

The acquisition unit 11A acquires an instruction to execute the print job given by the user by using the input unit 42 of the apparatus 40. In this case, the acquisition unit 11A acquires printed material data that is document data instructed by the user to be printed.

The acquisition unit 11A also acquires content designation information. The content designation information is information indicating what a content designated from the printed material data by the user is like, the content being designated for printing to be performed by the image forming apparatus 20.

The acquisition unit 11A also acquires selection information. The selection information is information indicating that in a case where the presentation unit 11C (described later) presents a print-candidate image to the user, the user has input an instruction to the image forming apparatus 20 to print the print-candidate image, by using the input unit 42 of the apparatus 40.

The acquisition unit 11A also acquires non-selection information. The non-selection information is information indicating that in the case where the presentation unit 11C (described later) presents a print-candidate image to the user, the user has input an instruction to the image forming apparatus 20 not to print the print-candidate image, by using the input unit 42 of the apparatus 40.

The acquisition unit 11A also acquires generated layout information. The generated layout information is a layout in which the content designated by the user is disposed, the layout being generated by the user themselves by using the input unit 42 of the apparatus 40. The term “new layout” in the present disclosure denotes a new layout compared with the layout stored in the layout database 13B.

The user may generate generated layout information in response to the input of the non-selection information that is an instruction to the image forming apparatus 20 not to print the presented print-candidate image.

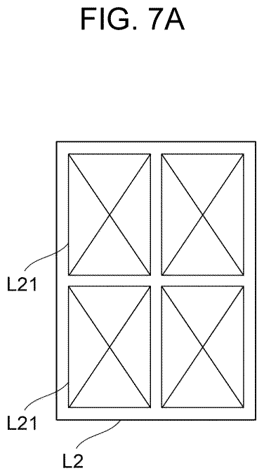

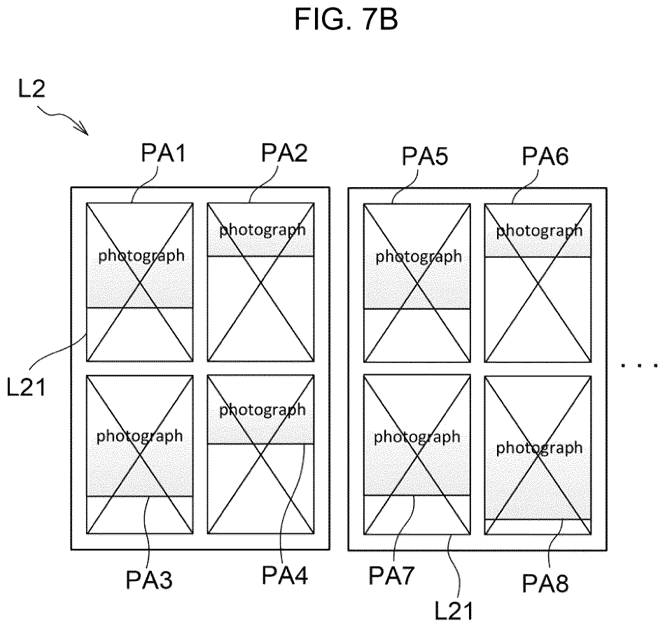

The user designates the location, the shape, and the size of the region where the content is disposed in the printed material and thereby may generate the generated layout information. The region where the content is disposed is designated by using a location, a shape, and a size for disposing the content on one printed material sheet, for example, like frames L21 in a layout L2 (described later) (see FIGS. 7A and 7B). An interface for the user to generate the generated layout information is displayed on the display 44.

### Extraction Unit

### Extracting Content

The extraction unit 11B extracts a print-designated content acquired by the acquisition unit 11A from the printed material data.

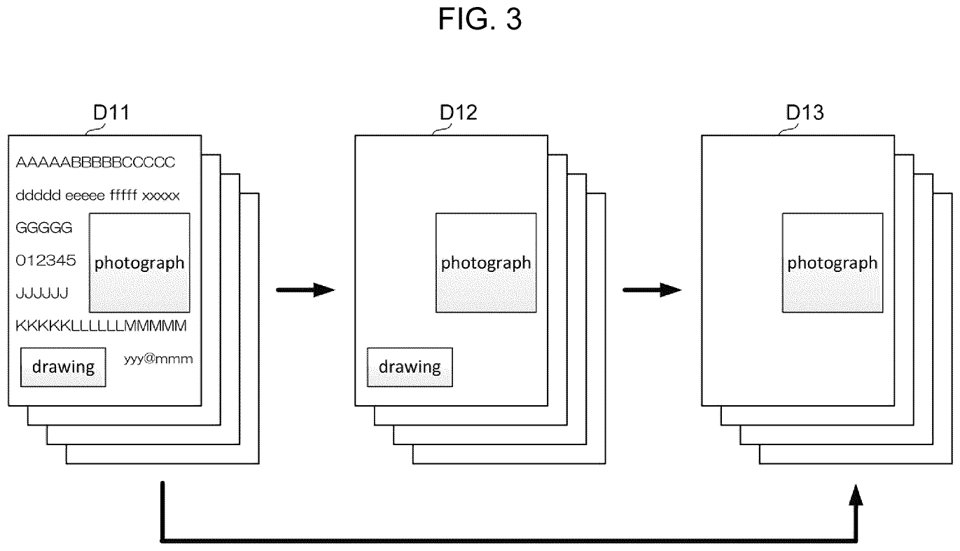

For example, as illustrated in FIG. 3, a case where “image” is designated for a content to be printed from printed material data D11 including characters and images will be described. In this case, the extraction unit 11B extracts images from the printed material data D11 as illustrated in extracted data D12.

For example, a case where “photo” in the subclassification of “image” is designated for a content to be printed will be described. In this case, the extraction unit 11B first extracts images from the printed material data D11 and further extracts a photo from the extracted data D12 as illustrated in extracted data D13.

If “photo” is designated for a content to be printed, the extraction unit 11B may directly extract a photo from the printed material data D11 as illustrated in the extracted data D13.

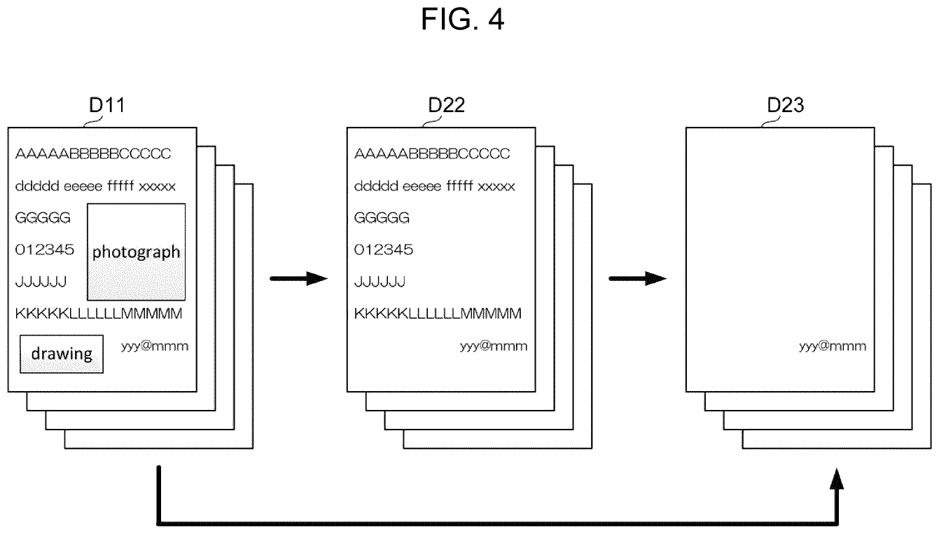

For example, as illustrated in FIG. 4, a case where “character” is designated for a content to be printed from the printed material data D11 including characters and images will be described. In this case, the extraction unit 11B extracts characters from the printed material data D11 as illustrated in extracted data D22.

For example, a case where “e-mail address” in the subclassification of “character” is designated for a content to be printed will be described. In this case, the extraction unit 11B first extracts characters from the printed material data D11 and further extracts an e-mail address from the extracted data D12 as illustrated in extracted data D23.

If “e-mail address” is designated for a content to be printed, the extraction unit 11B may directly extract an e-mail address from the printed material data D11 as illustrated in the extracted data D23.

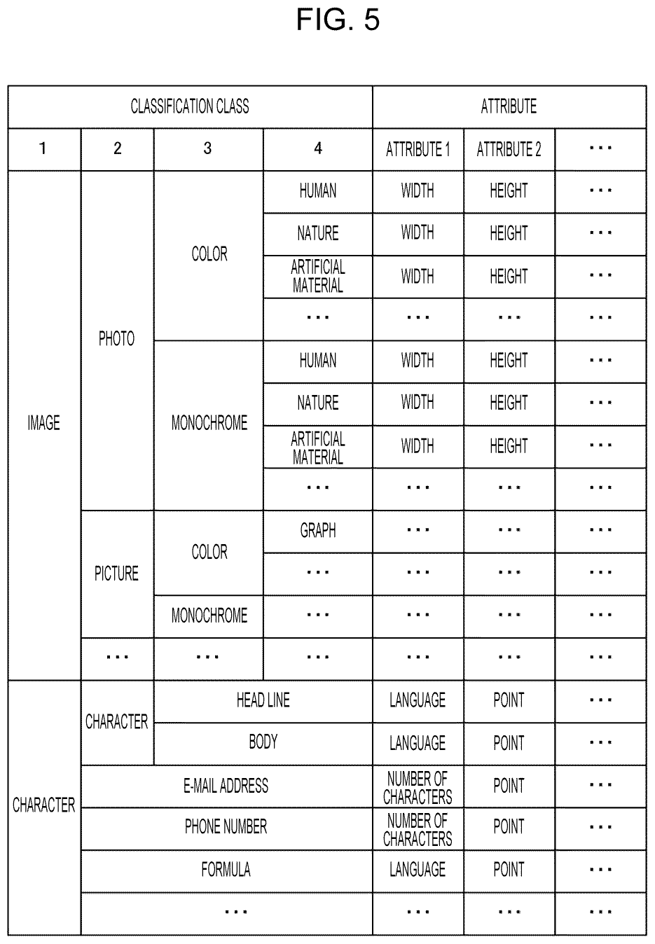

Contents allowed to be designated for printing by the user and attributes to be extracted for the respective contents by the extraction unit 11B are stored in the memory 13 as illustrated in FIG. 5.

Classification Class 1 illustrated in FIG. 5 is a class for dividing the contents into large groups of “image” and “character”. Classification Classes 2, 3, and 4 are classes for serially subclassifying the contents. The classes for classifying the contents may include further subclassifications. The user may designate any content for printing from the contents stored in the classification classes.

Each content illustrated in FIG. 5 is an example, and other contents may be stored, in the memory, as the contents allowed to be designated for printing by the user. If the user designates a content other than the contents stored in the memory for printing, the user selects a similar content from the contents stored in the memory.

The user may designate, for printing, various contents belonging to Classification Classes 1, 2, 3, 4 . . . . For example, the user may designate, for printing, an image or a character string belonging to the highest Classification Class 1.

### Extracting Attribute

The extraction unit 11B extracts an attribute of a print-designated content. For example, if the print-designated content is an image, the extraction unit 11B extracts the size (the width and the height) of the image as an attribute. For example, if the print-designated content is a character string, the extraction unit 11B extracts a character size (point) as an attribute.

As illustrated in FIG. 5, attributes to be extracted by the extraction unit 11B are stored in the memory 13 for each content. Each attribute illustrated in FIG. 5 is an example, and the extraction unit 11B may extract other attributes for each content.

### Presentation Unit

The presentation unit 11C may present a print-candidate image in which a print-designated content is disposed in a layout “different” from the layout of the printed material data. The term “present” denotes presenting to the user by using the display 44 of the apparatus 40.

The presentation unit 11C may also present a print-candidate image in which a print-designated content is disposed in a layout identical to the layout of the printed material data.

If the user designates the disposition of content in the layout identical to the layout of the printed material data together with a content to be printed, the presentation unit 11C presents a print-candidate image in which the content is disposed in the layout identical to the layout of the printed material data.

### Presenting Print-Candidate Image of Image

Regarding a print-candidate image in the layout identical to or different from the layout of the printed material data, a case where a content designated for printing from, for example, the printed material data D11 illustrated in FIG. 3 is a photo will be described.

The layout identical to the layout of the printed material data D11 is the layout illustrated for the extracted data D13. That is, the photo included in the printed material data D11 is disposed without the location and the size being changed.

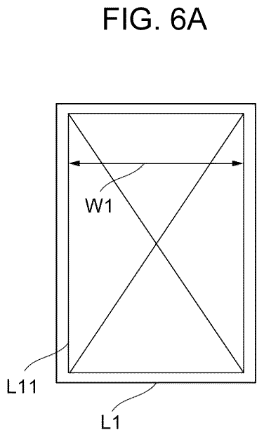

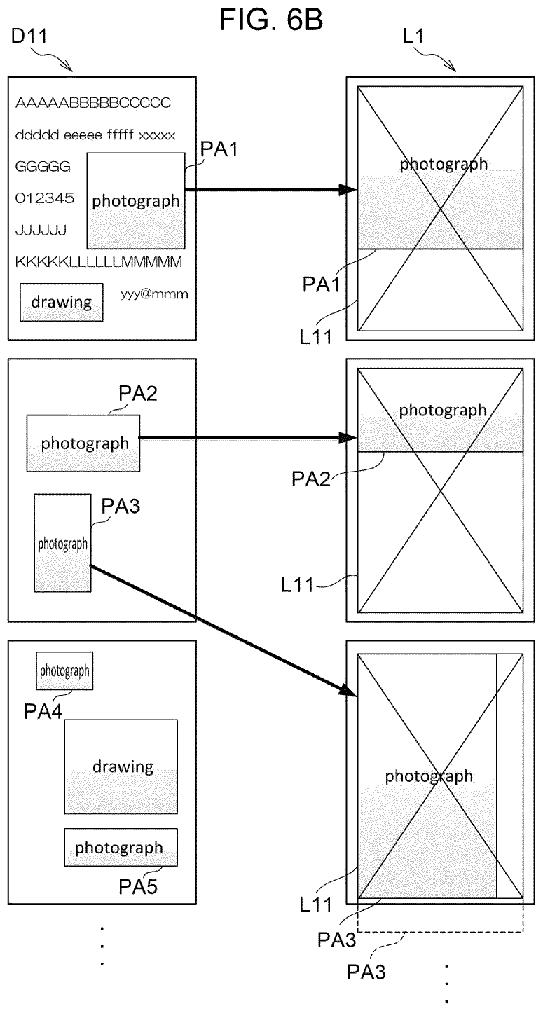

In contrast, the layout different from the layout of the printed material data D11 is, for example, a layout L1 illustrated in FIG. 6A. In the layout L1, one photo is disposed on one page of the printed material. A width W1 of the photo is constant as much as possible. The term “as much as possible” is used as long as the entire photo is printed on one page of the printed material (described later).

A frame L11 with diagonal lines crossing each other that is depicted in the layout L1 represents a disposition region for one image and is not printed. Each frame L21 depicted in the layout L2 illustrated in FIG. 7A also represents a disposition region for one image and is not printed.

As described above, the term “layout” in the present disclosure denotes a template by which a region where a content is disposed. A content is disposed in the region designated in accordance with the template, and thereby a print-candidate image is generated. Conversion data that is data to be actually printed is also generated.

If the photo included in the printed material data D11 is disposed in the layout L1, the contents are disposed in the layout L1 in such a manner as to be enlarged and to have the same width W1, for example, as for photos PA1 and PA2 in the printed material data D11 illustrated in FIG. 6B.

However, if a content is enlarged to have the width W1 as for a photo PA3 and thus has a height causing protrusion from the printing range as represented by the broken line, the content is enlarged to a size that fits entirely on one printed material sheet. In this case, the width of the photo PA3 disposed in the layout L1 does not become the width W1.

The presentation unit 11C may present a print-candidate image in which the photo is disposed in the layout L1 as described above. The layout L1 as described above is referred to as a width-aligned 1up layout L1 on occasions in the following description.

Various layouts in which a content is disposed, such as the layout L1, are stored in the layout database 13B of the memory 13.

Examples of the layout for disposing an image include the layout in which one image is disposed on one page of the printed material such as the layout L1 and the layout in which multiple (for example, four) images are disposed on one page of the printed material such as the layout L2 illustrated in FIG. 7A. In this case, any of the contents (the photos PA1 to PA8 . . . ) is disposed in such a manner as to be reduced on the basis of the attribute thereof on occasions.

As described above, various layouts for which the number of images per printed material sheet are designated are recorded in the layout database 13B. The presentation unit 11C presents each print-candidate image in which a content processed (for example, enlarged or reduced) on the basis of the extracted attribute (for example, the width and the height) of the image is disposed in the corresponding layout.

### Presenting Print-Candidate Image of Characters

Regarding a print-candidate image disposed in the layout identical to or different from the layout of the printed material data, a case where a content designated for printing from, for example, the printed material data D11 illustrated in FIG. 4 is an e-mail address will be described.

The layout identical to the layout of the printed material data D11 is the layout illustrated for the extracted data D23. That is, the e-mail address included in the printed material data D11 is disposed without the location and the size being changed.

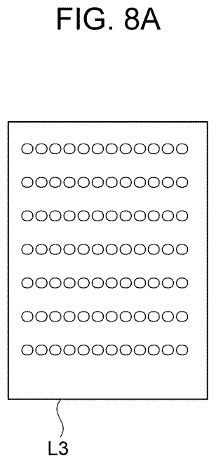

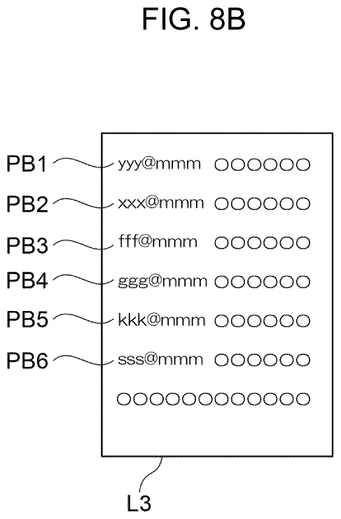

In contrast, the layout different from the layout of the printed material data D11 is, for example, a layout L3 illustrated in FIG. 8A. In the layout L3, the maximum values of the number of lines and the number of characters per line of characters on one page of the printed material have been designated. Circles disposed widthwise and lengthwise and depicted in the layout L3 indicate places where the characters are disposed and are not printed.

The presentation unit 11C may dispose characters in the layout L3 for which the number of lines of characters per printed material sheet is designated as described above in such a manner as to enlarge or reduce the characters on the basis of a character size.

For example, if e-mail addresses included in the printed material data D11 are disposed in the layout L3, the e-mail addresses are disposed in the layout L3 in such a manner that the size of each content (point) is enlarged or reduced as occasion demands, for example, as e-mail addresses PB1, PB2, . . . in the printed material data D11 illustrated in FIG. 8B are disposed.

The presentation unit 11C may present a print-candidate image in which the e-mail addresses are disposed in the layout L3 as described above.

Various layouts for which the number of characters per printed material sheet and the disposition of characters are designated are recorded in the layout database 13B. Examples of the disposition of characters include a multicolumn layout (one-column composition or two-column composition).

The presentation unit 11C presents a print-candidate image in which a content processed (for example, enlarged or reduced) on the basis of the extracted attribute (for example, the point of a font) is disposed in the corresponding layout.

### Presenting Print-Candidate Image Including Multiple Contents

The user may designate multiple types of contents for printing. For example, the user may designate, for printing, a photo of a person that is an image and an e-mail address that is a character string. In this case, the presentation unit 11C may dispose the print-designated contents in the layout in association with each other. For example, the presentation unit 11C may present a print-candidate image in which the photo of a person and the e-mail address are disposed in proximity to each other.

### How Print-Candidate Image is Presented

As described above, the layout database 13B stores the various layouts. Multiple types of layouts are stored for each content. The presentation unit 11C presents a print-candidate image in which a content is disposed in a layout read out from the multiple layouts stored in the layout database 13B.

For example, if the content is an image, not only a width-aligned 1up layout L1 but also a width-aligned 2up layout, a width-aligned 4up layout, a height-aligned 1up layout, a height-aligned 2up layout, a height-aligned 4up layout, and other layouts are stored in the layout database 13B as described above. These layouts are also stored for each orientation of the printed material.

The various layouts stored in the layout database 13B are also stored with priority based on the content. The priority is priority in the presentation to the user. The priority is not limited to the examples described below and may be set freely by, for example, an administrator of the information processing system 80.

The presentation unit 11C first presents a print-candidate image in which a content designated by the user is disposed in the highest priority layout as a layout for disposing the content.

For example, a case where the user designates an image as a content to be printed will be described. The presentation unit 11C presents, to the user, a print-candidate image in which an image is disposed in the width-aligned 1up layout L1 with the highest priority as the layout for disposing the image.

At this time, through an input operation by the user by using the input unit 42 of the apparatus 40, the acquisition unit 11A acquires one of selection information, non-selection information, and non-selection information and generated layout information.

If the acquisition unit 11A acquires the non-selection information but does not acquire the generated layout information, the presentation unit 11C presents, to the user, a print-candidate image in which the content is disposed in a different layout (the next highest priority layout). At this time, one or more print-candidate images may be presented.

When the acquisition unit 11A acquires the non-selection information and the generated layout information, the presentation unit 11C presents a print-candidate image in which the content is disposed in a new layout generated on the basis of the input operation by the user.

### Instruction Unit

When the acquisition unit 11A acquires the selection information, the instruction unit 11D gives the image forming apparatus 20 an instruction to execute a print job for conversion data generated on the basis of the selected print-candidate image. The conversion data is data for a printed material on which the content designated by the user for printing is disposed in the layout stored in the layout database 13B or the layout generated by the user.

### Print-Candidate Image Presentation Process

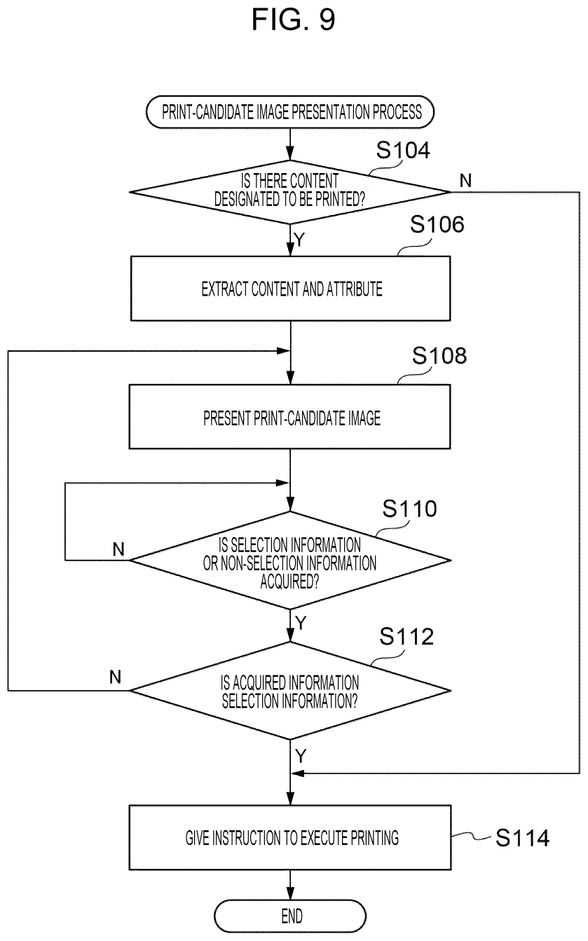

The CPU 11 of the controller 10 executes a print-candidate image presentation process illustrated in FIG. 9 in response to an instruction to execute a print job given by the user by using the input unit 42 of the apparatus 40.

Upon execution of the print-candidate image presentation process, the CPU 11 determines in step S104 whether there is a print-designated content in response to the print-job execution instruction. If the result in step S104 is affirmative, the process proceeds to step S106. In contrast, if the result in step S104 is negative, that is, if all of the contents included in the printed material data are to be printed, the process proceeds to step S114.

In step S106, the CPU 11 extracts the print-designated content from the printed material data and further extracts the attribute of the print-designated content. After step S106, the process proceeds to step S108.

In step S108, the CPU 11 presents a print-candidate image in which the print-designated content is disposed. After step S108, the process proceeds to step S110.

In step S110, the CPU 11 waits to acquire selection information or non-selection information. If the CPU 11 acquires the selection information or the non-selection information, the process proceeds to step S112. If the non-selection information in addition to the generated layout information is acquired in step S110, the process also proceeds to step S112.

In step S112, the CPU 11 determines whether the acquired information is selection information. If the result in step S112 is affirmative, the process proceeds to step S114. In contrast, if the result in step S112 is negative, that is, if the information acquired by the CPU 11 is the non-selection information, the process returns to step S108.

If the CPU 11 acquires the non-selection information in addition to the generated layout information in step S110, the CPU 11 presents a print-candidate image in step S108 after step S112 is performed, the print-candidate image having the print-designated content disposed in the generated layout generated by the user.

In step S114, the CPU 11 gives the image forming apparatus 20 an instruction to execute the print job for the conversion data generated on the basis of the selected print-candidate image. The print-candidate image presentation process is thus terminated.

### Actions and Effects

With the information processing system 80 of the present disclosure, a content designated by the user for printing may be extracted from printed material data for which the user has instructed to execute a print job. A print-candidate image in which the content is disposed in the layout different from the layout of the original printed material data may be presented to the user. Conversion data generated on the basis of the print-candidate image selected by the user may be printed by the image forming apparatus 20.

That is, only one or more print-designated contents may be printed in a state where one or more contents not designated by the user for printing are not printed. Each print-designated content thus has higher visibility than in a case where each content not designated for printing is printed.

An image may also be disposed in such a manner as to be enlarged or reduced on the basis of the size of an image in a layout (for example, the layouts L1 and L2) for which the number of images per printed material sheet is designated. Likewise, a character string may be disposed in such a manner as to be enlarged or reduced on the basis of the character size in a layout (for example, the layout L3) for which the number of lines of characters per printed material sheet is designated.

Print-designated contents may thus be disposed in such a manner as to have the same size and to be aligned. The print-designated content thereby has higher visibility than in a case where images and characters are neither enlarged nor reduced.

With the information processing system 80 of the present disclosure, a print-candidate image in which a print-designated content is disposed in the layout identical to the layout of the printed material data may also be presented. The user thus may verify where the print-designated content is printed in the printed material, by using the display 44.

With the information processing system 80 of the present disclosure, if a print-candidate image presented by the presentation unit 11C is not selected by the user, a print-candidate image in which a content designated by the user for printing is disposed in a different layout may be presented.

As described above, presenting print-candidate images in multiple layouts causes a printed material in which a content is disposed in a layout desired by the user to be acquired more easily than in a case where only a print-candidate image in one layout is presented.

With the information processing system 80 of the present disclosure, if a print-candidate image presented by the presentation unit 11C is not selected by the user, a print-candidate image in which a content is disposed in a new layout generated on the basis of an input operation by the user may be presented.

As described above, presenting a print-candidate image in a layout generated by the user causes a printed material in which the content is disposed in a layout desired by the user to be acquired more easily than in a case where the user is not allowed to generate a layout.

With the information processing system 80 of the present disclosure, the extraction unit 11B may extract an attribute of a print-designated content, and the presentation unit 11C may present a print-candidate image in which the content processed on the basis of the extracted attribute is disposed in a layout.

The presentation unit 11C may thereby present the print-candidate image in which the content processed on the basis of the attribute is disposed in the layout. For example, the presentation unit 11C may present a print-candidate image in which an image enlarged or reduced (processed) on the basis of a width or a height serving as the attribute is disposed in the layout.

### Other Exemplary Embodiments

In the exemplary embodiment above, a print-candidate image in which a print-designated content is disposed in the layout identical to the layout of printed material data may be presented; however, the exemplary embodiment of the present disclosure is not limited to this. For example, only a print-candidate image in which a print-designated content is disposed in a layout different from the layout of the printed material data may be presented.

In the exemplary embodiment above, if the presented print-candidate image is not selected, a print-candidate image in which the content is disposed in a different layout is presented, that is, multiple print-candidate images are presented on the basis of the multiple layouts; however, the exemplary embodiment of the present disclosure is not limited to this. For example, only one type of print-candidate image may be presented.

In the exemplary embodiment above, if the presented print-candidate image is not selected, a print-candidate image in which the content is disposed in a new layout generated on the basis of an input operation by the user is presented; however, the exemplary embodiment of the present disclosure is not limited to this. For example, the layout generation based on the input operation by the user does not have to be performed.

In the exemplary embodiment above, enlarging or reducing on the basis of a width, a height, or point as processing a content on the basis of an attribute has heretofore been described; however, the exemplary embodiment of the present disclosure is not limited to this.

Examples of the processing on the basis of an attribute include changing color on the basis of color (printing in a single color), translating on the basis of language (printing in one language), and changing a font (illustration omitted in FIG. 5) on the basis of a font.

In the exemplary embodiment above, the presentation unit 11C processes a content on the basis of the attribute; however, the exemplary embodiment of the present disclosure is not limited to this. For example, the presentation unit 11C does not have to process the content. In an example, the presentation unit 11C may present a print-candidate image in which an image is disposed in a layout without enlarging and reducing the image.

In the exemplary embodiment above, in the hardware configuration of the processing unit that executes processes by, for example, the acquisition unit 11A, the extraction unit 11B, the presentation unit 11C, and the instruction unit 11D, various processors described below may be used. As described above, the various processors above include, in addition to a CPU that is a general processor that functions as the processing unit by running software (a program), a programmable logic device (PLD) that is a processor capable of changing the circuit configuration after being manufactured such as a field-programmable gate array (FPGA), a dedicated electric circuit that is a processor having a circuit configuration designed exclusively for executing a specific process such as an application specific integrated circuit (ASIC), and other processors.

The processing unit may be configured from one of these various processors or may be configured by combining two or more processors of the same type or different types (for example, combining multiple FPGAs or combining a CPU and a FPGA). The processing unit may also be configured from one processor. Part or all of these processors may be configured on the cloud. At least the processes described in the exemplary embodiment above may be executed by the processor on the cloud.

In a first example of the processing unit configured from one processor, as represented by a computer such as a server or a client, one processor is configured by combining one or more CPUs and software, and the processor functions as the processing unit. In a second example, as represented by a system on chip (SoC) or the like, a processor in which the overall system function including the processing unit is implemented by one integrated circuit (IC) chip is used. As described above, in the hardware configuration, the processing unit is configured by using at least one of the various processors.

Further, more specifically, in the hardware configuration of these various processors, an electric circuit (circuitry) combined with a circuit element such as a semiconductor device may be used. As described above, the present disclosure may be implemented in various forms.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system includes: at least one processor configured to:
extract a content designated for printing from printed material data; and
present a print-candidate image in which the content designated for printing is disposed in a layout different from a layout of the printed material data.
   (((2)))

In the information processing system according to (((1))),
the processor is configured to:
   present the print-candidate image in which the content designated for printing is disposed in a layout identical to the layout of the printed material data.
      (((3)))

In the information processing system according to (((1))) or (((2))),
the processor is configured to:
   present the print-candidate image in which the content is disposed in a layout read out from multiple layouts stored in a memory; and
   in response to the presented print-candidate image not being selected, present the print-candidate image in which the content is disposed in a different layout.
      (((4)))

In the information processing system according to (((3))),
the processor is configured to:
   read out the different layout from a database stored in the memory and dispose the content in the different layout.
      (((5))) In the information processing system according to any one of (((1))) to (((4))),
the processor is configured to:
   in response to the presented print-candidate image not being selected,
      present the print-candidate image in which the content is disposed in a new layout generated on a basis of an input operation by a user.
         (((6)))

In the information processing system according to any one of (((1))) to (((5))),
the processor is configured to:
   extract an attribute of the content designated for printing and present the print-candidate image in which the content processed on a basis of the extracted attribute is disposed in the layout.
      (((7)))

In the information processing system according to (((6))),
the processor is configured to:
   in response to the content being an image, extract a size of the image as the attribute; and
   enlarge or reduce the image on a basis of the size of the image and dispose the image in the layout for which a count of the image per printed material sheet is designated.
      (((8)))

In the information processing system according to (((6))),
the processor is configured to:
   in response to the content being a character, extract a size of the character as the attribute; and
   enlarge or reduce the character on a basis of the size of the character and dispose the character in the layout for which a count of a line of the character per printed material sheet is designated.
      (((9)))

In the information processing system according to any one of (((1))) to (((8))),
the processor is configured to:
   in response to multiple contents are designated for printing,
   dispose each of the contents in the layout in association with each other and present the print-candidate image.
      (((10)))

An information processing program causes a computer to execute a process including:
extracting a content designated for printing from printed material data; and
presenting a print-candidate image in which the content designated for printing is disposed in a layout different from a layout of the printed material data.
   (((11)))

An information processing method including:
extracting a content designated for printing from printed material data; and
presenting a print-candidate image in which the content designated for printing is disposed in a layout different from a layout of the printed material data.

What is claimed is:

1. An information processing system comprising:
at least one processor configured to:
extract a content designated for printing from printed material data; and
present a print-candidate image in which the content designated for printing is disposed in a layout different from a layout of the printed material data.

2. The information processing system according to claim 1,
wherein the processor is configured to:
present the print-candidate image in which the content designated for printing is disposed in a layout identical to the layout of the printed material data.

3. The information processing system according to claim 1,
wherein the processor is configured to:
present the print-candidate image in which the content is disposed in a layout read out from a plurality of layouts stored in a memory; and
in response to the presented print-candidate image not being selected, present the print-candidate image in which the content is disposed in a different layout.

4. The information processing system according to claim 3,
wherein the processor is configured to:
read out the different layout from a database stored in the memory and dispose the content in the different layout.

5. The information processing system according to claim 1,
wherein the processor is configured to:
in response to the presented print-candidate image not being selected,
present the print-candidate image in which the content is disposed in a new layout generated on a basis of an input operation by a user.

6. The information processing system according to claim 1,
wherein the processor is configured to:
extract an attribute of the content designated for printing and present the print-candidate image in which the content processed on a basis of the extracted attribute is disposed in the layout.

7. The information processing system according to claim 6,
wherein the processor is configured to:
in response to the content being an image, extract a size of the image as the attribute; and
enlarge or reduce the image on a basis of the size of the image and dispose the image in the layout for which a count of the image per printed material sheet is designated.

8. The information processing system according to claim 6,
wherein the processor is configured to:
in response to the content being a character, extract a size of the character as the attribute; and
enlarge or reduce the character on a basis of the size of the character and dispose the character in the layout for which a count of a line of the character per printed material sheet is designated.

9. The information processing system according to claim 1,
wherein the processor is configured to:
in response to a plurality of the contents are designated for printing,
dispose each of the contents in the layout in association with each other and present the print-candidate image.

10. A non-transitory computer readable medium storing a program causing a computer to execute a process for information processing, the process comprising:
extracting a content designated for printing from printed material data; and
presenting a print-candidate image in which the content designated for printing is disposed in a layout different from a layout of the printed material data.

11. An information processing method comprising:
extracting a content designated for printing from printed material data; and
presenting a print-candidate image in which the content designated for printing is disposed in a layout different from a layout of the printed material data.
